(19) United States
(12) Patent Application Publication
(10) Pub. No.: US 2007/0267134 A1
(43) Pub. Date: Nov. 22, 2007

(54) Photoinitiated Cationic Epoxy Compositions

(76) Inventors: Mark M. Konarski, Old Saybrook, CT (US); Susan L. Levandoski, Bristol, CT (US)

Correspondence Address: LOCTITE CORPORATION, 1001 TROUT BROOK CROSSING, ROCKY HILL, CT, 06067, US

(21) Appl. No.: 11/574,096

(22) PCT Filed: Sep. 2, 2005
(86) PCT No.: PCT/US05/31567

§ 371 Date: Feb. 22, 2007

Related U.S. Application Data
(60) Provisional application No. 60/606,893, filed on Sep. 3, 2004.

(51) Int. Cl. C08G 59/68

(52) U.S. Cl. 156/273.3; 522/101; 522/11; 522/170; 522/25; 522/27; 522/28; 522/29; 522/30

(57) ABSTRACT

The present invention is directed to photoinitiated cationic epoxy compositions, which show a delayed onset of cure resulting in controllable “open times” for the end user consumer. These compositions are activated by exposure to electromagnetic radiation, such as UV radiation with a wavelength In the range of 254-405 nm, but show a commercially meaningful “open time” and then cure even in shaded zones to achieve a desired final adhesive strength.

### BACKGROUND OF THE INVENTION

1. Field of the Invention

The present invention is directed to photoinitiated cationic epoxy compositions, which show a delayed onset of cure resulting in controllable “open times” for the end user consumer. These compositions are activated by exposure to electromagnetic radiation, such as UV radiation with a wavelength in the range of 254-405 nm, but show a commercially meaningful “open time” and then cure even in shaded zones to achieve a desired final adhesive strength.

2. Brief Description of Related Technology

Photoinitiated, cationically curable adhesive compositions based on epoxy resins have many benefits and advantages desirable to end user consumers. For example, such compositions provide cured products having physical properties comparable to those from a thermosetting composition (though without the application of heat necessary to cure such compositions which oftentimes may compromise the integrity of the substrate to be joined or other components thereon), such compositions are less inhibited by oxygen than a photoinitated free radical curable composition (resulting in faster and more thorough cure), and such compositions exhibit less shrinkage during cure than otherwise comparable photoinitiated free radical curable compositions (such as those based on acrylic chemistry).

Photoinitiated cationic adhesive compositions have, therefore, been used in various well-known applications such as a liquid crystal display and lamination in a digital video disk.

Ciba Specialty Chemicals has for some time sold a cationic photoinitiator product called IRGACURE 261 [(⁵-2,4-cyclopentadien-1-yl)[(1,2,3,4,5,6,-)-(1-methyl ethyl)benzene]-iron(+)-hexafluorophosphate(−1)] which is suggested in its product literature to be used with a peroxide or thioxanthone for best curing results.

Japanese Patent Publication No. JP-A 6-73159 appears to describe cationically photocurable epoxy resin compositions, with talc or cordierite added to a fluorinated epoxy resin.

Photoinitiated, cationically curable epoxy resin compositions, which contain a ferrocenium complex salt, a compound containing cycloaliphatic epoxide groups as well as a mixture of polyethylene glycol and -butyrolactone as a solvent, have also been disclosed in European Patent Document No. EP 344 910. The composition is intended for use for protective coatings and as a binder for magnetic particles or abrasives and as binders and in the printing industry.

Photoinitiated, cationically curable epoxy resin compositions, which contain trivalent phenols, an organic peroxide, a ferrocenium complex salt and a cycloaliphatic epoxy, are also known. See e.g. German Patent Document No. DE 20 25 814.

European Patent Document No. EP 661 324 discloses a photoinitiated, cationically curable epoxy composition, which is reported to consist of 0.0001 to 10 parts of an inhibiting agent (that delays the increase of viscosity of the composition), 0.001 to 10 parts of an accelerator 0.1 to 5 parts of a ferrocenium complex salt, 10 to 99.5 parts of a cycloaliphatic epoxy, and optionally a variety of different additives in an amount of 0 to 60 parts. The inhibiting agent is described to be a reducing active substance (such as ascorbic acid or oxalic acid), basic substance (such as alcoholates or amimes), complexing agent or chelating agent (such as -diketones, 8-hydroxyquinolines or oximes). This composition is reported to remain workable for at least 30 seconds after exposure to light having a wavelength in the range of 380-700 nm. The additives are selected from flexibility agents, radically polymerizable oligomers, fillers, pigments, dyes and stabilizers.

It is known that cure rate is dependent upon catalyst concentration and light intensity. For instance, page 3965 of J. V. Crivello and J. L. Lee, J. Poly. Sci.: Part A, 27, 3951-3968 (1989) presents a table (reproduced below) that shows the effect of photoinitiator concentration on the UV cure of the epoxy, limonene dioxide (a cycloaliphatic epoxy).

| | UV Cure Rate* | | | |
|---|---|---|---|---|
| Photoinitiator | 2 Lamps | 1 Lamp | 1 Lamp | 1 Lamp |
| Concentration (%) | (300 W) | (300 W) | (200 W) | (120 W) |
| 0.5 | >500 | 350 | — | 50 |
| 1.0 | >500 | >500 | — | 100 |
| 2.0 | >500 | >500 | >500 | 150 |
| 3.0 | >500 | >500 | >500 | 250 |

*Determined on a RPC UV Processor using 1 mil films on glass substrates; cure rates are in ft/min.

However, when these findings are used in practice to attempt to produce a delay in gellation (or increase in open time) in epoxy compositions, the relatively low level of active catalyst species becomes depleted by quenching reactions with trace contaminants and/or ambient moisture. This effect has been recognized by M. D. Soucek and J. Chen, J. of Coatings Tech., 75, 937 (Feb. 2003). See also FIG. 3 herein, which illustrates the lower level of percent cure.

Despite the state of the technology, it would be desirable to provide end user consumers with a variety of alternative technologies with which to satisfy their product assembly needs, particularly when it comes to improving the open time of adhesives which gives end user consumers greater flexibility in their assembly procedures. In addition, it would be desirable to provide end user consumers with technologies that offer improved performance properties, such as shear strength.

It is also known to use oxetanes (the four membered counterpart to epoxies or oxiranes) in photoinduced cationic cure systems. See J. V. Crivello et al., “Photoinduced Cationic Ring-Opening Frontal Polymerizations of Oxetanes and Oxiranes”, J. Polym. Sci.: Part A: Polym. Chem., 42, 1630-46 (2004); U.S. Patent Application Publication No. 2005/0092428; A. Kuriyama, “Investigation of Cationic Curable Oxetane Resins” (Undated) and OXT technical report, Toa Gosei Co., Ltd. (Undated).

There has been an on-going desire to find photoinitiated adhesive compositions, because photocure mechanisms are ordinarily more rapid than heat cure mechanisms, and occur without exposure to the heat applied during heat cure, which is known to compromise the integrity of certain substrates sought to be assembled. Thus, use of such photoinitiated adhesive compositions minimizes the tendency of compromising the integrity of the overall device, part and/or substrate.

### SUMMARY OF THE INVENTION

In one aspect, the present invention seizes upon the discovery that use of an appropriate cationic photoinitiator and free radical phenone initiator allows for the formulation of a photoinitiated cationically curable epoxy composition with delay cure onset. In this composition, the use of an appropriate cationic photoinitiator and free radical initiator generates free radicals that lead to a redox-induced decomposition mechanism of the cationic photoinitiator.

Thus, the invention provides a photoinitiated cationically curable composition, including an aliphatic epoxy resin, at least a portion of which includes an aliphatic glycidyl ether (such as a non-aromatic glycidyl ether epoxy resin like a hydrogenated bisphenol A or F epoxy resin); a cationic photoinitiator; and a free radical initiator (such as one having a phenone). When exposed to appropriate radiation in the electromagnetic spectrum (such as UV in the range of 254-405 nm), the inventive compositions are capable of achieving an open time of from 1 second to about five minutes (before gelling occurs rendering it unsuitable for adhesive applications), and developing greater than about 85% of its ultimate strength after a period of time of 24 hours at room temperature. Significantly, the inventive compositions may achieve greater than about 85% of their ultimate cure without exposure to elevated temperature conditions. And the composition is capable of curing through a thickness of at least about 1 mm.

A particularly desirable composition within the scope of the invention includes a hydrogenated bisphenol A epoxy resin (such as EPALLOY 5000), a cationic photoinitiator (such as RHODASIL 2074) and a free radical co-initiator (such as benzophenone). Another particularly desirable composition within the scope of the invention includes EPALLOY 5000, RHODASIL 2074 and benzophenone, with one or more of a glycidyl ether of an alkyl polyol, such as a butanediol diglycidyl ether (such as EPODIL 750 or ERISYS GE-21), and a polyester ether polyol reactive diluent (such as K-FLEX 128 or TONE 0201, 0210 or 0310). The inventive compositions are capable of demonstrating significant improvement in open time or delayed cure characteristics and physical properties, such as shear strengh on metals and plastic substrates.

In another aspect, the compositions are curable upon exposure to radiation in the visible range of the electromagnetic spectrum.

In still another aspect, the compositions include (meth)acryl-terminated and alkoxy silyl-terminated polyacrylates available commercially from Kaneka Corporation, Japan and VAMAC-brand tougheners available commercially from DuPont, which impart a variety of physical properties including improved toughness and improved adhesion.

In yet another aspect, the compositions include oxetane-containing compounds, which impart improved photocure and/or toughness.

The invention is also directed to methods of preparing such compositions, methods of using such compositions, assembling devices with such compositions, and reaction products of such compositions as well as the so-assembled devices.

### BRIEF DESCRIPTION OF THE FIGURES

FIG. 1 depicts a plot of gel time of formulations within the scope of the present invention after UV exposure and the effect of different ratios of an initiator system.

FIG. 2 depicts a plot of comparative shear strengths of a comparative sample, DELO 4552, and two formulations within the scope of the present invention.

FIG. 3 depicts a plot of cationic cure reactivity over time of a comparative sample based on a cycloaliphatic epoxy resin and formulations within the scope of the present invention.

FIG. 4 depicts a bar chart of impact strength for hydrogenated bisphenol A epoxy resin/oxetane combinations at 20 phr (and a control without oxetane) with UVI-6976, and with and without IRGACURE 184, showing the extent of UV photocure.

FIG. 5 depicts a bar chart of DPC peak maxima of hydrogenated bisphenol A epoxy resin/oxetane combinations at 20 phr (and a control without oxetane) with UVI-6976, and with and without IRGACURE 184, showing the relative times required to reach DPC peak maxima.

### DETAILED DESCRIPTION OF THE INVENTION

As noted above, the invention provides a photoinitiated cationically curable composition, comprising an aliphatic epoxy resin, at least a portion of which includes an aliphatic glycidyl ether; a cationic photoinitiator; and a free radical initiator.

The aliphatic epoxy resin of the present invention may include many aliphatic epoxy resins, such as those having mono-, di- or poly-epoxy functionality, for instance, functionality in the form of glycidyl ethers. Embraced within the aliphatic epoxy resin are those within the following structure 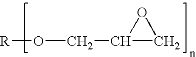
where n is 1-7 and R is any non-aromatic hydrocarbon, optionally containing ether or ester linkages. R therefore may be alkyl, alkenyl or cycloalkyl.

Examples of such epoxy resins include C₂-C₇₀ alkyl and alkenyl glycidyl ethers; C₂-C₇₀ alkyl and alkenyl glycidyl esters (such as epoxidized castor oils); hydrogenated mono- and poly-phenolic glycidyl ethers; polyglycidyl ethers of hydrogenated pyrocatechol, hydrogenated resorcinol, hydrogenated hydroquinone (or 1,4-dihydroxy cyclohexane), 4,4′-dihydroxydicyclohexyl methane (or hydrogenated bisphenol F), 4,4′-dihydroxy-3,3′-dihydroxydicyclohexyl methane, 4,4′-dihydroxydicyclohexyl dimethyl methane (or hydrogenated bisphenol A, such as EPALLOY 5000), 4,4′-dihydroxydicyclohexyl methyl methane, 4,4′-dihydroxydicyclohexyl cyclohexane, 4,4′-dihydroxy-3,3′-dimethyldicyclohexyl propane, 4,4′-dihydroxydicyclohexyl sulfone (or hydrogenated bisphenol S), tris(4-hydroxycyclohexyl)methane, butanediol diglycidyl ether and combinations thereof.

Among the commercially available epoxy resins suitable for use in the present invention are glycidyl derivatives of: hydrogenated phenolic compounds, such as those available from Resolution Performance, under the EPON tradename, such as EPON 1009F [bisphenol A epoxy resin (CAS No. 25036-25-3)] or EPON 1510, which itself is the diglycidyl ether of hydrogenated bisphenol A epoxy resin or EPALLOY 5000, which is hydrogenated bisphenol A epoxy resin and is available commercially from CVC Chemical Corporation, EPON 1001F, EPON 1002F, EPON 1004F, EPON 1007F, EPON 3001, EPON 3002, EPON 2002, EPON 2003, EPON 2004, EPON 2005, EPON 2012, EPON 2014, EPON 2024, and EPON 2042, or SU-8 (bisphenol A-type epoxy novolac); from Dow Chemical Co. under the DER trade designation, such as DER 331, DER 332, DER 383, DER 354, and DER 542; from Vantico Inc., Brewster, N.Y. under the ARALDITE tradename, such as ARALDITE [phenol-4,4′-(1-methylethylidene)bis with (chloromethyl)oxirane (CAS No. 25068-38-6)], ARALDITE ECN 1299 [formaldehyde, polymer with (chloromethyl)oxirane and 2-methylphenol, melting point 85-100° C. (CAS No. 29690-82-2)] and ARALDITE ECN 1285 [formaldehyde, polymer with (chloromethyl)oxirane and 2-methylphenol, melting point 80-90° C. (CAS No. 29690-82-2)], and ARALDITE GT 7097 US [(phenol, 4-(1,1-dimethylethyl), polymer with (chloromethyl)oxirane and 4,4′-(1-methylethylidene)bis, melting point 113-123° C. (CAS No. 67924-34-9)]; and from Nippon Kayaku, Japan, BREN-S (a brominated epoxy resin, which is particularly useful for fire retardancy). Cresol analogs are also available commercially under the tradenames ECN 1235, ECN 1273, and ECN 1299 from Ciba Specialty Chemicals. And of course combinations of the different epoxy resins are also desirable for use herein.

The epoxy resin should be used in an amount up to about 99 percent by weight, such as about 45 to about 98 percent by weight, desirably about 85 to about 95 percent by weight of the composition.

As the cationic photoinitiator, appropriate choices include those having as a counter ion a phosphorous or antimony metal complex with the appropriate number of halogen (such as fluorine) atoms per metal atom. In the context of surface mount electronic component attachment, see U.S. Pat. No. 4,916,805 (Ellrich), which discloses certain photoinitiators having counter ions, such as PF₆⁻, BF₄⁻, AsF₆⁻ and SbF₆⁻.

Suitable cationic photoinitiators for use herein also include onium salts represented by the general formula:
[R²²-A⁺][X⁻]
where R²² is an aromatic radical, for instance aryl, alkaryl, and aralkyl groups, including fused ring structures comprising an aromatic ring, which may be optionally substituted with a linear, branched or cyclic C₈ to C₂₀ radical of alkyl, alkylene, alkoxy alkyleneoxy, a nitrogen, oxygen or sulfur heterocyclic radical of 4 to 6 carbon atoms in the ring; or a mixture thereof, A⁺ is selected from iodonium cation mono-substituted with C₁ to C₂₀ alkyl or aryl optionally substituted with C₁ to C₂₀ alkyl or alkoxy and sulfonium cation di-substituted with C₁ to C₂₀ alkyl or aryl optionally substituted with C₁ to C₂₀ alkyl or alkoxy or a mixture thereof and X⁻ is a non-basic, non-nucleophilic anion, examples of which include PF₆⁻, BF₄⁻, AsF₆⁻, SbF₆⁻, ClO₄⁻, CF₃SO₃⁻ and the like. Examples of such cationic photoinitiators are diaryliodonium, triarylsulfonium, diaryliodosonium, triarylsulfoxonium, dialkylphenacylsulfonium and alkylhydroxyphenylsulfonium salts. See e.g. U.S. Pat. No. 4,219,654 (Crivello); U.S. Pat. No. 4,058,400 (Crivello); U.S. Pat. No. 4,058,401 (Crivello) and U.S. Pat. No. 5,079,378 (Crivello).

In addition, triarylsulfonium and diaryliodonium salts containing non-nucleophilic counterions are appropriate choices, examples of which include diphenyl iodonium chloride, diphenyl iodonium hexafluorophosphate, 4,4-dioctyloxydiphenyl iodonium hexafluorophosphate, triphenylsulfonium tetrafluoroborate, diphenyltolylsulfonium hexafluorophosphate, phenylditolylsulfonium hexafluoroarsenate, and diphenylthiophenoxyphenylsulfonium hexafluoroantimonate, and those commercially available from Sartomer, Exton, PA under the SARCAT tradename, such as SARCAT CD 1010 [triaryl sulfonium hexafluoroantimonate (50% in propylene carbonate)]; SARCAT DC 1011 [triaryl sulfonium hexafluorophosphate (50% n-propylene carbonate)]; SARCAT DC 1012 (diaryl iodonium hexafluoroantimonate); SARCAT K185 [triaryl sulfonium hexafluorophosphate (50% in propylene carbonate)] and SARCAT SR1010 [triarylsulfonium hexafluoroantimonate (50% in propylene carbonate)]; and SARCAT SR1012 (diaryliodonium hexafluoroantimonate), and those commercially available from Dow under the CYRACURE tradename, such as UVI-6976 (mixed triarylsulfonium hexafluoroantimonate salts); UVI-6992 (mixed triarylsulfonium hexafluorophosphate salts).

Additional cationic photoinitiators include UV 9385C (an alkylphenyl iodonium hexafluorophosphate salts) and UV 9390C (an alkylphenyl iodonium/hexafluoroantimonate salt) available commercially from General Electric Corporation; CGI 552 (an alkylphenyl iodonium hexafluorophosphate salt); and RADCURE UVACure 1590 available commercially from UCB, Belgium.

Rhodia Chemie make available commercially a cationic photoinitiator for silicone-based release coatings, whose counter ion contains fluoride atoms covalently bound to aromatic carbon atoms of the counter ion, such as B(C₆F₅)₄. See International Patent Application Nos. PCT/FR97/00566 and PCT/FR98/00741. See also Rhone-Poulenc Chemie's U.S. Pat. No. 5,550,265 (Castellanos), U.S. Pat. No. 5,668,192 (Castellanos), U.S. Pat. No. 6,147,184 (Castellanos), and U.S. Pat. No. 6,153,661 (Castellanos).

In addition, a cationic photoinitiator having a core cation within structure I below: 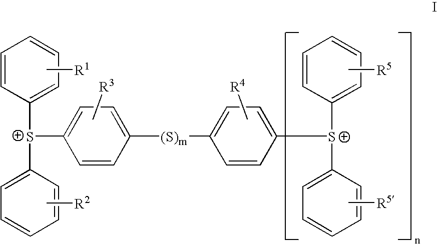
where R¹, R², R³, R⁴, R⁵ and R⁵′ may or may not be present, but when not present are hydrogen and when any are present may individually be selected from C₁₋₆ alkyl, C₂₋₆ alkenyl, halogen, hydroxyl and carboxyl, with R¹, R², and R⁵ being present individually up to 5 times on each aromatic ring to which it(they) is(are) attached, and R³ and R⁴ being present individually up to 4 times on each aromatic ring to which it(they) is(are) attached, n is 0-3 and m is 0-1.

More specific examples of cationic photoinitiators having core cations within structure I include those represented by structures II and III:

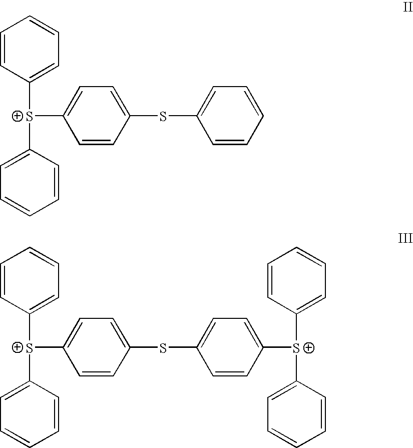

In addition, appropriate cationic photoinitiators include those having core cations within structures IV, V, and VI: 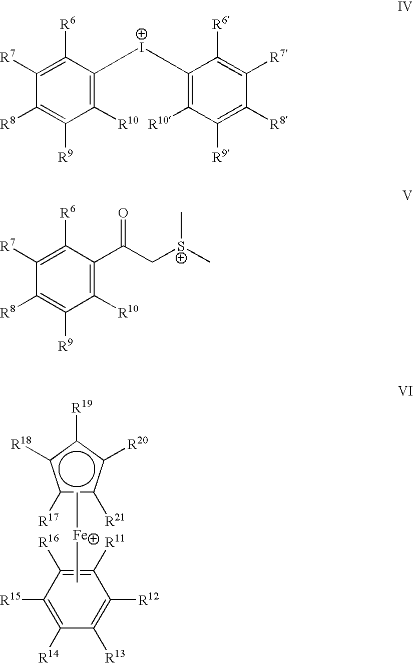
where for structures IV R⁶, R⁷, R⁸, R⁹ and R¹⁰ may or may not be present, but when not present are hydrogen and when any are present may individually be selected from alkyl, such as from 1 to 5 carbon atoms, halogen, hydroxyl, and carboxyl, for structure V R⁶, R⁷, R⁸, R⁹, R¹⁰, R⁶′, R⁷′, R⁸′, R⁹′, and R¹⁰′ may or may not be present, but when not present are hydrogen and when any are present may individually be selected from hydrogen, alkyl, such as from 1 to 5 carbon atoms, halogen, hydroxyl, and carboxyl, and for structure VI R¹¹, R¹² R¹³, R¹⁴, R¹⁵, R¹⁶, R¹⁷, R¹⁸, R¹⁹, R²⁰, and R²¹ may or may not be present, but when not present are hydrogen and when any are present may individually be selected from hydrogen, alkyl, such as from 1 to 5 carbon atoms, halogen, hydroxyl, and carboxyl.

More specific examples of cationic photoinitiators having core cations within structure IV, V and VI include those represented by structures VII(a) and VII(b), VIII and IX (the latter of which being available commercially under the tradename IRGACURE 261 from Ciba Specialty Checicals), respectively:

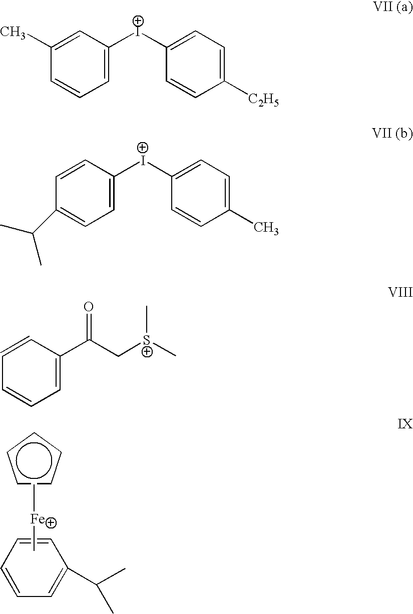

Structure VII(b) is the cationic portion of the photoinitiator called RHODOSIL 2074, commercially available from Rhodia Chemie, whose chemical name is tolylcumyl iodonium tetrakis(pentafluorophenyl)borate (CAS No. 178233-72-2).

The cationic photoinitiator should be used in the invention in an amount up to about 5 percent by weight, such as about 0.01 to about 3, desirably 0.5 to 2 percent by weight of the composition.

As a free radical initiator, many suitable materials are available, though benzophenone, 1-hydroxycyclohexyl phenyl ketone, and 2,2-dimethoxy-2-phenyl acetophenone are particularly desirable. Of course, combinations of these free radical phenone initiators are desirable. The latter is available commercially from Ciba under the tradename IRGACURE 651, while the former two in a 1:1 by weight ratio are also available from Ciba under the tradename IRGACURE 500. Other free radical initiators available commercially from Ciba include 2-benzyl-2-N,N-dimethylamino-1-(4-morpholino phenyl)-1-butane (IRGACURE 369), 2-methyl-1-[4(methylthio)phenyl]-2-morpholino propane-1-one (IRGACURE 907), 2-hydroxyl-2-methyl-1-phenyl-propane-1-one (DAROCURE 1173), 1-hydroxycyclohexyl phenyl ketone, 2,2-dimethoxy-2-phenyl acetophenone, bis(2, 6-dimethoxybenzoyl-2, 4,4-trimethyl pentyl) phosphine oxide, bis(2,4,6-trimethyl benzoyl) phenyl phosphine oxide, 4-(2-hydroxyethyoxy)phenyl-(2-hydroxy-2-methylpropyl)ketone, 2,4, 6-trimethylbenzoyl-diphenylphosphine oxide, and combinations thereof.

The free radical initiator should be used in an amount up to about 5 percent by weight, such as about 0.01 to about 3 percent by weight, desirably 0.5 to 2 percent by weight of the composition.

The cationic photoinitiator and the free radical initiator should be used in a ratio of 4:1 to 1:4, such as 2:1 to 1:2, for instance 1.5:1 to 1:1.5, to achieve the open times demonstrated herein and as modified within that range by the end user consumer, depending on the end user consumer preferences.

In addition to the cationic photoinitiator and the free radical initiator, in one aspect of the invention a visible light photoinitiator and/or photosentitizer may be included. An example of such a material is camphorquinone (“CPQ”), though others such as 9-fluorene carboxylic acid peroxyesters, visible light [blue] photoinitiators, IRGACURE 784DC (photoinitiator based on substituted titanocenes), and combinations thereof, may be used as well.

Other suitable photoinitiator systems triggered in the visible range of electromagnetic spectrum may be used and include those disclosed in each of the following patent documents, each of which being incorporated by reference herein in its entirety.

U.S. Pat. No. 4,505,793 (Tamoto) discloses photopolymerization initiators that include a combination of a 3-keto-substituted cumarin compound and an active halogeno compound. A number of exemplary compounds are disclosed. Such photopolymerization initiators cure by exposure to light having wavelengths ranging between about 180 nm and 600 nm.

U.S. Pat. No. 4,258,123 (Nagashima) discloses photosensitive resin compositions including initiator components that generate a free radical upon irradiation with actinic light. Such components include various triazine compounds, as more fully described therein.

European Patent Publication No. EP 0 369 645 A1 discloses a three-part photoinitiator system which includes a trihalomethyl substituted-s-triazine, a sensitizing compound capable of absorbing radiation in the range of about 300-1000 nm and an electron donor. Exemplary sensitizing compounds are disclosed, including ketones; coumarin dyes; xanthene dyes; 3H-xanthen-3-one dyes; acridine dyes; thiazole dyes; thiazine dyes; oxazine dyes; azine dyes; aminoketone dyes; methane and polymethine dyes; porphyrins; aromatic polycyclic hydrocarbons; p-substituted aminostyryl ketone compounds; aminotriaryl methanes; merocyanines; squarylium dyes; and pyridinium dyes. Exemplary donors also are disclosed, including amines; amides; ethers; ureas; ferrocene; sulfinic acids and their salts; salts of ferrocyanide; ascorbic acid and its salts; dithiocarbamic acid and its salts; salts of xanthates; salts of ethylene diamine tetraacetic acid; and salts of tetraphenylboronic acid. Such initiators are sensitive to both UV and visible light.

European Patent Publication No. EP 0 563 925 A1 discloses photopolymerization initiators including a sensitizing compound that is capable of absorbing radiation in the range of about 250-1000 nm and 2-aryl-4,6-bis(trichloromethyl)-1,3,5-triazine. Exemplary sensitizing compounds that are disclosed, including cyanine dye, merocyanine dye, coumarin dye, ketocoumarin dye, (thio)xanthene dye, acridine dye, thiazole dye, thiazine dye, oxazine dye, azine dye, aminoketone dye, squarylium dye, pyridinium dye, (thia)pyrylium dye, porphyrin dye, triaryl methane dye, (poly)methane dye, amino styryl compounds. and aromatic polycyclic hydrocarbons. These photopolymerization initiators are sensitive to UV and visible light.

U.S. Pat. No. 5,395,862 (Neckers) discloses fluorone photoinitiators, which are sensitive to visible light. Such fluorone initiator systems also include a coinitiator, which is capable of accepting an electron from the excited fluorone species. Exemplary coinitiators are disclosed, including: onium salts, nitrohalomethanes and diazosulfones. U.S. Pat. No. 5,451,343 (Neckers) discloses fluorone and pyronin-Y derivatives as initiators that absorb light at wavelengths of greater than 350 nm. U.S. Pat. No. 5,545,676 (Palazzotto) discloses a three-part photoinitiator system, which cures under UV or visible light. The three-part system includes an arylidonium salt, a sensitizing compound and an electron donor. Exemplary iodonium salts include diphenyliodonium salts. Exemplary sensitizers and electron donors for use in the three-part system also are disclosed. Additionally, the sensitizer is capable of absorbing light in the range of about 300-1000 nm.

These photoinitiators triggered in the visible range of the electromagnetic spectrum may be employed in amounts of about 0.1% to about 10% by weight of the total composition. More desirably, these photoinitiators are present when used in amounts of 0.5% to about 5% by weight of the total composition.

When used, these photoinitiators permit the inventive compositions to cure dry-to-the-touch, forming reaction products with tack free exterior surfaces.

The inclusion of such a photoinitiator broadens the energy sources available to cure the inventive composition. For instance, where such a photoinitiator is present, a LED device generating radiation in or about 470 mm may be used to cure the inventive compositions. Such a LED device is described for instance in International Patent Publication No. WO 04/011848 and International Patent Application No. PCT/US2005/016900, the disclosure of each of which being incorporated herein by reference.

In another aspect, oxetane-containing compounds may be included in the inventive compositions. These oxetane-containing compounds seem to improve photocure and/or toughness of the composition. Examples of such oxetanes include 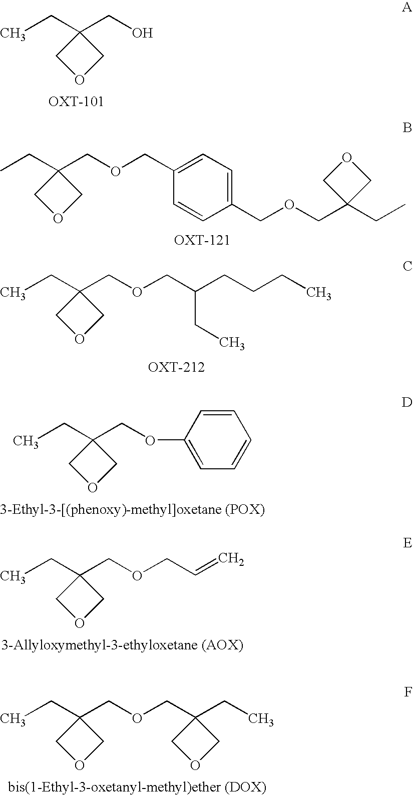
Oxetanes labeled A-C are available from Toa Gosei Co., Ltd., Japan.

As a reactive diluent, many materials are useful, including polyols generally, such as diols generally for instance dibenzyl alcohol. More specifically, the polyester and/or polyether diols and polyols available commercially from King Industries, such as those under the trade designations K-FLEX 128 (polyester/polyether diol) and K-FLEX XM-A307 (polyester diol), or TONE 0201, 0210 or 0310 are desirable. The reactive diluent may be added to modify the glass transition temperature (“Tg”) and modulus of the cured reaction product by participating in the cross-linking reaction with the epoxy under cure conditions. The reactive diluents also improve adhesion on substrates constructed from various plastic or synthetic materials, and oftentimes metals.

In order to toughen such compositions, an oxetane-containing compound may be included, as noted. In addition or alternatively, an alkoxy silyl-terminated polyacrylate may be included.

Such polyacrylates accordingly have at least one terminal group represented by
—SiRA₃

The number of these groups is not particularly restricted, but is desirably not less than 1 per molecule. In some embodiments, the number of these groups is 1.2 to 4.

R^{A} in each case in that terminal group may be the same or different, and represents hydrogen or a C₁ to C₂₀ hydrocarbon radical, thus including such species as —H, —CH₃, —CH₂CH₃, —(CH₂)ₙCH₃ (n=an integer of 2 to 19), —C₆H₅, —CH₂OH, phenyl, alkoxy and —CN, provided that in at least one instance R^{A} is alkoxy.

As used herein, the term “hydrocarbon radical” is intended to refer to radicals which are primarily composed of carbon and hydrogen atoms. Thus, the term encompasses aliphatic groups such as alkyl, alkenyl, and alkynyl groups; aromatic groups such as phenyl; and alicyclic groups, such as cycloalkyl and cycloalkenyl.

The alkoxy silyl-terminated polyacrylate may be represented by the following structure: 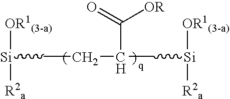
where R is as described above in connection with R^{A} of the terminal group, a is integer from 0-3, and q is an integer from 1 to about 1,000. Desirably, a is 1 or 2. R¹ in each occurrence may be the same or different and is a C₁ to C₂₀ hydrocarbon radical. In a desirable aspect, R¹ is C₁ to C₆ alkyl. More desirably, R¹ is C₁ to C₃ alkyl.

R² in each occurrence may be the same or different, and is a C₁ to C₁₀ hydrocarbon radical. Substituent R², in combination with the oxygen to which it is attached, forms a hydrolyzable group, which provides the compositions of the present invention with their ability to undergo room temperature vulcanization (“RTV”). RTV cure typically occurs through exposure of the compositions of the present invention to moisture. The presence of hydrolyzable moisture curing groups, such as alkoxy groups, on the silicon atom permits the compositions of the present invention to crosslink. Suitable hydrolyzable groups include alkoxy groups such as methoxy, ethoxy, propoxy, and butoxy; aryl groups such as phenoxy; acyloxy groups such as acetoxy; aryloxy groups such as phenoxy; and alkoxyalkyl groups such as CH₃OCH₂CH₂—. Larger groups such as propoxy and butoxy are slower to react than smaller groups such as methoxy and ethoxy. Accordingly, the rate at which the compositions of the invention undergo moisture cure can be influenced by choosing appropriately sized groups for substituent R². Desirably, R² is C₁-C₄ alkyl. More desirably, R² is methyl or ethyl.

In a particularly desirable aspect, the alkoxy silyl-terminated polyacrylates are available commercially from Kaneka Corporation, such as those referred to as Telechelic Polyacrylates, and are available under trade designation ORlOOS.

Likewise, an alkyl (meth)acrylate polyacrylate may be included. More specifically, the alkyl (meth)acrylate polyacrylate may be a homopolymer of C₁-C₁₀ (meth)acrylates or a copolymer of C₁-C₁₀ (meth)acrylates. Suitable alkyl acrylates include, but are not limited to, ethyl acrylate, butyl acrylate and 2-ethylhexyl acrylate. Copolymeric acrylate elastomers or rubbers may contain copolymerized units of up to 40 weight percent monovinyl monomers, for example, styrene, acrylonitrile, vinylbutyl ether, acrylic acid and C₁-C₁₀ alkyl acrylates different from the principal alkyl acrylate comonomer.

The elastomer may also be a polyfunctional (meth)acrylate polymer. Such polymers may have a high degree of functionality due to the presence of multiple functional groups in the main chain of the polymer, as well as functional terminal groups. In some embodiments, such elastomers may include a polyfunctional (meth)acrylate portion and at least one monofunctional (meth)acrylate portion. The polyfunctional (meth)acrylate portion may compose the main chain of the polymer while the monofunctional (meth)acrylate portions are terminal groups.

For example, the elastomer may be a (meth)acryloyl-terminated vinyl polymer. Such vinyl polymers accordingly may have at least one terminal group per molecule represented by:
—OC(O)C(R)═CH₂

The number of these groups per molecule is not particularly restricted, but is desirably not less than 1 per molecule. In some embodiments, the number of the groups per molecule is 1.2 to 4.

R represents hydrogen or an organic group of 1 to 20 carbon atoms. Desirably, R is hydrogen or a hydrocarbon group of 1 to 20 carbon atoms, thus including such species as —H, —CH₃, —CH₂CH₃, —(CH₂)ₙCH₃, where n is an integer of 2 to 19, —C₆H₅, —CH₂OH and —CN, among others. More desired are —H and —CH₃.

The main chain of the polymer may be multifunctional, thereby imparting a higher degree of functionality to the polymer than the alkyl (meth)acrylate polymers described above. The main chain of the vinyl polymer desirably is comprised of a (meth)acrylic polymer, more desirably comprised of an acrylic ester polymer. A styrenic polymer also may be used.

The monomer to form the main chain of the vinyl polymer is not particularly restricted but a variety of monomers may be selectively employed. Suitable examples include, but are not limited to, (meth)acrylic monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, -(methacryloyloxypropyl)trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, and 2-perfluorohexadecylethyl (meth)acrylate; styrenic monomers such as styrene, vinyltoluene, -methylstyrene, chlorostyrene, styrenesulfonic acid and its salt; fluorine-containing vinyl monomers such as perfluoroethylene, perfluoropropylene, and vinylidene fluoride; silicon-containing vinyl monomers such as vinyltrimethoxysilane and vinyltriethoxysilane; maleic anhydride, maleic acid, monoalkyl esters and dialkyl esters of maleic acid; fumaric acid and monoalkyl esters and dialkyl esters of fumaric acid; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide and cyclohexylmaleimide; nitrile-containing vinyl monomers such as acrylonitrile and methacrylonitrile; amide-containing vinyl monomers such as acrylamide and methacrylamide; vinyl esters such as vinyl acetate, vinyl propionate, vinyl pivalate, vinyl benzoate and vinyl cinnamate; alkenes such as ethylene and propylene; conjugated dienes such as butadiene and isoprene; vinyl chloride, vinylidene chloride, allyl chloride and allyl alcohol. These monomers may be used alone or comnined in a copolymerization product.

The vinyl polymer may have a molecular weight distribution, i.e., the ratio of weight average molecular weight to number average molecular weight as determined by gel permeation chromatography, of less than 1.8, preferably not more than 1.7, more preferably not more than 1.6, still more preferably not more than 1.5, particularly not more than 1.4, most preferably not more than 1.3.

The number average molecular weight of the vinyl polymer may be 500 to 100,000, more desirably 3,000 to 40,000.

Such vinyl polymers are described more fully in European Patent Publication No. EP 1 059 308 A1. See also U.S. Pat. No. 5,852,129 (Kusabe) and U.S. Pat. No. 6,274,688 (Nakagawa), the disclosures of each of which are hereby incorporated herein by reference.

The elastomers may be prepared in accordance with the disclosure set forth in U.S. Pat. No. 5,312,871 (Mardare) and U.S. Pat. No. 5,763,548 (Matyjaszewski). In addition, the disclosures of each of which are hereby incorporated herein by reference.

In the living radical polymerization process, various techniques are available. For instance, use of a cobalt porphyrin complex, as shown in J. Am. Chem. Soc., 116, 7943 (1994); use of a radical scavenger such as a nitroxide compound, as shown in Macromolecules, 27, 7228 (1994); and an atom transfer radical polymerization (“ATRP”) process using an organic halide or the like as an initiator and a transition metal complex as a catalyst.

Among these living radical polymerization processes, the atom transfer radical polymerization process in which a vinyl monomer is polymerized using an organic halide or a halogenated sulfonyl compound as an initiator and a transition metal complex as a catalyst is a living radical polymerization and also has a halogenated terminus, which is relatively useful for functional group conversion reaction, and the initiator and catalyst have high degrees of design freedom. Examples of the atom transfer radical polymerization process include the processes disclosed in Matyjaszewski, et al., J. Am. Chem. Soc., 117, 5614 (1995); Macromolecules, 28, 7901 (1995); Science, 272, 866 (1996); International Patent Publication Nos. WO 96/30421 and WO 97/18247; and Sawamoto, et al., Macromolecules, 28, 1721 (1995). See also International Patent Publication No. WO 2005/030866.

An inorganic filler component may also be advantageously included in the inventive composition. For instance, the inorganic filler component may often include reinforcing silicas, such as fused silicas, and may be untreated or treated so as to alter the chemical nature of their surface. Virtually any reinforcing fused silica may be used. Alternatively, the inorganic filler component may be a fumed silica, which may impart thixotropy to the composition.

Other desirable materials for use as the inorganic filler component include those constructed of or containing aluminum oxide, silicon nitride, aluminum nitride, silica-coated aluminum nitride and micronized quartz, provided they are not basic in nature.

Typically, the composition includes up to about 98 weight percent, such as an amount within the range of about 45 weight percent to about 90 weight percent, for instance from about 35 to about 80 weight percent, desirably about 60 to about 75 weight percent, of the epoxy resin component by weight of the total composition, up to about 25 weight percent of the reactive diluent by weight of the total composition, up to about 5 weight percent, such as about 0.01 to about 2 weight percent of the cationic photoinitiator, by weight of the total composition and up to about 5 weight percent, such as about 0.01 to about 2 weight percent of the free radical initiator, by weight of the total composition. Of course, depending on the particular set of properties desirable for a composition destined for a specific purpose these values may vary somewhat.

The present invention also provides methods for bonding a pair or more of substrates, using the compositions so described. More specifically, one such method includes the steps of applying such a composition to at least one substrate, activating the composition prior to, during or after appication thereof through exposure to radiation in the electromagnetic spectrum, such as UV radiation a wavelength in a range of 254-405 nm, to such an extent that a desired initial tackiness is maintained and no skin formation on the surface of the composition occurs; positioning the one substrate onto the other substrate; and allowing the composition to cure to bond the pair or more substrates, and optionally, speeding cure of the composition by exposure to a temperature between about 60 and about 175° C., such as about 80 to about 150° C.

Another such method of bonding substrates provided by the present invention uses at least one substrate which has less than 50% optical transmission. Such substrates may be colored and/or opaque. The steps of this method include providing a first substrate, providing a second substrate, where at least one of the first and second substrates has less than 50% optical transmission, providing the inventive composition on at least one of the first or second substrates, exposing the composition to conditions sufficient to initiate cure thereof, mating the first and second substrates, and allowing the composition to achieve greater than 85% of its ultimate strength.

As noted, the inventive compositions are capable of achieving an open time of from 1 second to about five minutes (before gelling occurs rendering it unsuitable for adhesive applications), and developing greater than about 85% of its ultimate cure after a period of time of 24 hours at room temperature.

The following examples are presented to further illustrate the invention, without intending to narrow or depart from its scope.

### EXAMPLES

In the following examples, samples were prepared from various epoxies and initiator systems to evaluate cure profiles and physical properties.

### Example 1

Table 1 below shows three otherwise comparable samples based on a cycloaliphatic epoxy resin that were prepared with free radical initiators (though not phenone based ones) and cationic photoinitiators.

TABLE 1

| Component | | Sample No./Amt. (Wt %) | | |
|---|---|---|---|---|
| Type | Identity | 1 | 2 | 3 |
| Cycloaliphatic | ERL 4221 | 100 | 100 | 100 |
| Epoxy Resin | | | | |
| Free Radical | Cumene | 1 | 0.67 | 0.5 |
| Initiator | hydroperoxide | | | |
| Cationic | IRGACURE 261 | 1 | 0.67 | 0.5 |
| Photoinitiator | | | | |

The samples were prepared using conventional techniques, and later dispensed onto glass substrates.

Table 2 below shows that these samples each exhibited poor cure profiles from a delay cure/open time stand point and cured properties at one weight percent, and at subsequently reduced levels of free radical initiator and cationic photoinitiator (each used in the same amount in each sample). More specifically, while delayed gellation was observed in Sample No. 3, poor cure properties were also observed, as evidenced by percent cure through a differential scanning calorimetry (“DSC”) evaluation with a 10° C./minute ramp, from a temperature of 35° C. to 200° C.

TABLE 2

| | Sample No. | | |
|---|---|---|---|
| Physical Property | 1 | 2 | 3 |
| Observations after 5″ | Gelled and | Gelled but | Initially liquid, skins |
| @ 50 mW photolysis | hard | tacky | over in 10 minutes |
| Cure %, after 24 hrs | 95% | 71% | Still liquid, |
| @ RT | | | >50% cure |

### Example 2

Table 3 below illustrates samples prepared with a higher level (2 weight percent) of cationic photoinitiator with different epoxy types. In addition, the samples listed in Table 3 have been prepared without a free radical initiator to illustrate that the use of an epoxy resin with low reactivity did not develop desirable properties to the extent achieved through the use of a hydrogenated aromatic backbone for the epoxy, as seen in Table 4. Though the use of an epoxy resin with low reactivity may result in a delayed cure, those evaluated in Tables 3 and 4 did not.

TABLE 3

| | Sample No. | | | |
|---|---|---|---|---|
| | 4 | 5 | 6 | 7 |
| Epoxy Type | Hydrogenated BPA | Cycloaliphatic | Flexible | DGEBPA* |
| | (EPALLOY 5000) | (UVR-6105) | cycloaliphatic | (EPON 828) |
| | | | (ERL 4299) | |

*diglycidyl ether of bisphenol A

Table 4 below shows the effect of such high level of cationic photoinitiator with the different epoxies (and without free radical initiator). For instance, as measured by DSC, the percent cure is higher (as much as 32 percent higher) for the hydrogenated BPA (Sample No. 4) than the other three epoxies (Sample Nos. 5-7), which are known to have low reactivity.

TABLE 4

| | Sample No. | | | |
|---|---|---|---|---|
| Physical Property | 4 | 5 | 6 | 7 |
| Delay in skin/gel | Yes, gels | No delay, | No delay, | No delay, |
| formation after | after | skin forms | skin forms | skin forms |
| 4″ @ 50 mW | 60″ | immediately | immediately | immediately |
| Cure % after | 81% | 55% | 76% | 75% |
| 24 hrs @ RT | | | | |

### Example 3

Table 5 below shows samples prepared from a hydrogenated aromatic (bisphenol A) epoxy resin (EPALLOY 5000), with and without a cationic photoinitiator and with three different free radical phenone initiators.

TABLE 5

| Component | | Sample No./Amt. (Wt. %) | | | | | |
|---|---|---|---|---|---|---|---|
| Identity | Type | 8 | 9 | 10 | 11 | 12 | 13 |
| Hydrogenated Aromatic | EPALLOY 5000 | 100 | 100 | 100 | 100 | 100 | 100 |
| Epoxy Resin | | | | | | | |
| Cationic Photoinitiator | RHODASIL 2074 | 1 | — | — | — | 1 | 1 |
| Free Radical | IRGACURE 184 | 1 | 1 | — | — | — | — |
| Phenone Initiator | IRGACURE 651 | — | — | 1 | — | 1 | — |
| | IRGACURE 2659 | — | — | — | 1 | — | 1 |

Table 6 below shows that these free radical phenone initiators (i.e., IRGACURE 184, 651 and 2659) do not provide an appreciable effect on ultimate cure (at a 1 weight percent level) after exposure to UV radiation (5 seconds at 50 mW, followed by 24 hours at room temperature) with an aliphatic epoxy resin epoxy (such as EPALLOY 5000) when used without cationic photoinitiators (such as RHODOSIL 2074).

TABLE 6

| | Sample No. | | | | | |
|---|---|---|---|---|---|---|
| Physical Property | 8 | 9 | 10 | 11 | 12 | 13 |
| Ultimate cure* | 87% | No cure | No cure | No cure | 89% | 86% |

*After 5 sec. @ 50 mW, plus 24 hrs @ RT

### Example 4

Table 7 below shows samples prepared from a hydrogenated aromatic epoxy resin (i.e., hydrogenated DEGBPA) with and without a cationic photoinitiator and with three different levels of a free radical initiator.

TABLE 7

| Component | | Sample No./Amt. (Wt. %) | | | |
|---|---|---|---|---|---|
| Identity | Type | 14 | 15 | 16 | 17 |
| Hydrogenated Aromatic | EPALLOY 5000 | 100 | 100 | 100 | 100 |
| Epoxy Resin | | | | | |
| Cationic Photoinitiator | RHODASIL 2074 | 1 | 1 | 1 | 1 |
| Free Radical Phenone | IRGACURE 651 | — | 0.5 | 1.0 | 1.5 |
| Initiator | | | | | |

Table 8 below shows that cure enhancement was observed when a free radical phenone initiator was included with a cationic photoinitiator in an aliphatic epoxy resin, such as hydrogenated bisphenol A epoxy resin. Contrast Sample Nos. 15-17 to Sample No. 14.

TABLE 8

Sample No.

| Physical Property | 14 | 15 | 16 | 17 |
|---|---|---|---|---|
| Delayed gel time | 4-5′ | 2′ | 40″ | 30″ |
| Ultimate cure* | 78% | 84% | 88% | 89% |

*After 5 sec. @ 50 mW, plus 24 hrs @ RT

### Example 5

The cationic photoinitiator/free radical phenone initiator system, RHODASIL 2074/IRGACURE 184, was evaluated at various concentration ratios in a hydrogenated bisphenol A epoxy resin (EPPALLOY 5000). The concentration ratios used were 1:1, 2:1 and 1:2, as shown below in Table 9.

TABLE 9

| Components | | Sample No./Amt. (Wt. %) | | |
|---|---|---|---|---|
| Type | Identity | 18 | 19 | 20 |
| Epoxy | EPALLOY 5000 | 97 | 98 | 97 |
| Cationic Photoinitiator | RHODASIL 2074 | 2 | 1 | 1 |
| Free Radical Initiator | IRGACURE 184 | 1 | 1 | 2 |

Sample No. 18-20 were evaluated for gel time after UV exposure, using an Oriel lamp as a UV light source having an intensity of 50 mW/cm² with the exposure time varying from 5 to 30 seconds as indicated below in Table 10 and illustrated graphically in FIG. 1. (In the figure, Sample No. 18 is the diamond, Sample No. 19 is the circle and Sample No. 20 is the triangle.)

TABLE 10

| Observation of Delay Cure | Gel Time after UV Exposure (sec) | | |
|---|---|---|---|
| after UV Exposure* (sec) | 18 | 19 | 20 |
| 5 | 40 | 60 | >120 |
| 7 | — | — | 120 |
| 10 | 30 | 40 | 60 |
| 15 | 15 | 30 | 30 |
| 20 | Cured | 10 | 25 |
| 30 | — | — | — |

*@ 50 mw/cm

The delayed cure time (or, open time) and gel time can be controlled generally by adjusting the photoinitiator free radical initiator level in combination with adjusting the UV intensity and exposure time.

### Example 6

A reactive diluent (polyether polyol, TONE 0201) was also formulated into compositions to evaluate impact on adhesion performance. The compositions with the reactive diluent (Sample Nos. 22 and 23) are compared with one without the reactive diluent (Sample No. 21).

TABLE 11

| Components | | Sample No./Amt. (Wt. %) | | |
|---|---|---|---|---|
| Type | Identity | 21 | 22 | 23 |
| Epoxy | EPALLOY 5000 | 98 | 88.0 | 78 |
| Cationic Photoinitiator | RHODASIL 2074 | 1 | 1 | 1 |
| Free Radical Initiator | IRGACURE 184 | 1 | 1 | 1 |
| Reactive Diluent | TONE 0201 | — | 10 | 20 |

The shear strength of these samples on various substrates is shown below in Table 12.

TABLE 12

| | Sample No./Shear Strength (psi) | | |
|---|---|---|---|
| Substrates | 21 | 22 | 23 |
| A1/A1 | 762 | 857 | 913 |
| GB Steel/GB Steel | 1720 | 2011 | 1835 |
| G-10/G-10* | 410 | 256 | 515 |
| PVC/PVC | 300 | 243 | 653 |
| ABS/ABS | 2145 | 310 | 2058 |

Note:
Samples were activated with 5 sec UV exposure @ 50 mw/cm² plus cure at 48 hours at room temperature.
*G-10 is an epoxy composite

These results indicate that a composition containing 20% of TONE 0201 (Sample No. 24) gave generally an increase in shear strength values on the plastic substrates evaluated, and aluminum.

### Example 7

Two formulations shown below in Tables 13 (Sample No. 24) and 14 (Sample No. 25) have the same components, but differ in the relative amount of a reactive diluent (K-FLEX 128).

TABLE 13
Sample No. 24
Rigid Composition

| Component | | |
|---|---|---|
| Type | Identity | Amt./(Wt. %) |
| Hydrogenated DBEBPA epoxy | EPALLOY 5000 | 70.75 |
| Butanediol diglycidyl ether | EPODIL 750 | 15.00 |
| Polyether-polyester polyol | K-FLEX 128 | 5.00 |
| Cationic photoinitiator | RHODOSIL 2074 | 0.75 |
| Free radical initiator | IRGACURE 500 | 1.00 |
| Fumed Silica Thixatrope | AEROSIL R202 | 2.50 |
| Glass Beads | Type VI, 0.0049″ | 5.00 |

TABLE 14
Sample No. 25
Flexible Composition

| Component | | |
|---|---|---|
| Type | Type | Amt./(Wt. %) |
| Hydrogenated DGEBPA epoxy | EPALLOY 5000 | 60.75 |
| Butanediol diglycidyl ether | EPODIL 750 | 10.00 |
| Polyether-polyester polyol | K-FLEX 128 | 20.00 |
| Cationic photoinitator | RHODOSIL 2074 | 0.75 |
| Free radical initiator | IRGACURE 500 | 1.00 |
| Fumed silica thixatrope | AEROSIL R202 | 2.50 |
| Glass beads | Type VI, 0.0049″ | 5.00 |

For comparative purposes, DELO 4552, promoted by the manufacturer as a delay cure cationic epoxy formulation, was used to determine how well compositions within the scope of the invention performed. Based on reported information from the manufacturer, analytical evaluations performed by Applicants' assignee and information reported in European Patent No. EP 661 324, what is believed to be known about the formulation of DELO 4552 is provided below in Table 15.

TABLE 15
Sample No. 26
DELO 4552

| Type | Identity |
|---|---|
| Cycloaliphatic epoxy | UVR-6110 |
| Ferrocenium salt photoinitator | IRGACURE 261 |
| Inhibitor | 8-hydroxy quinoline |
| Oxidative accelerator | Cumene hydroperoxide |

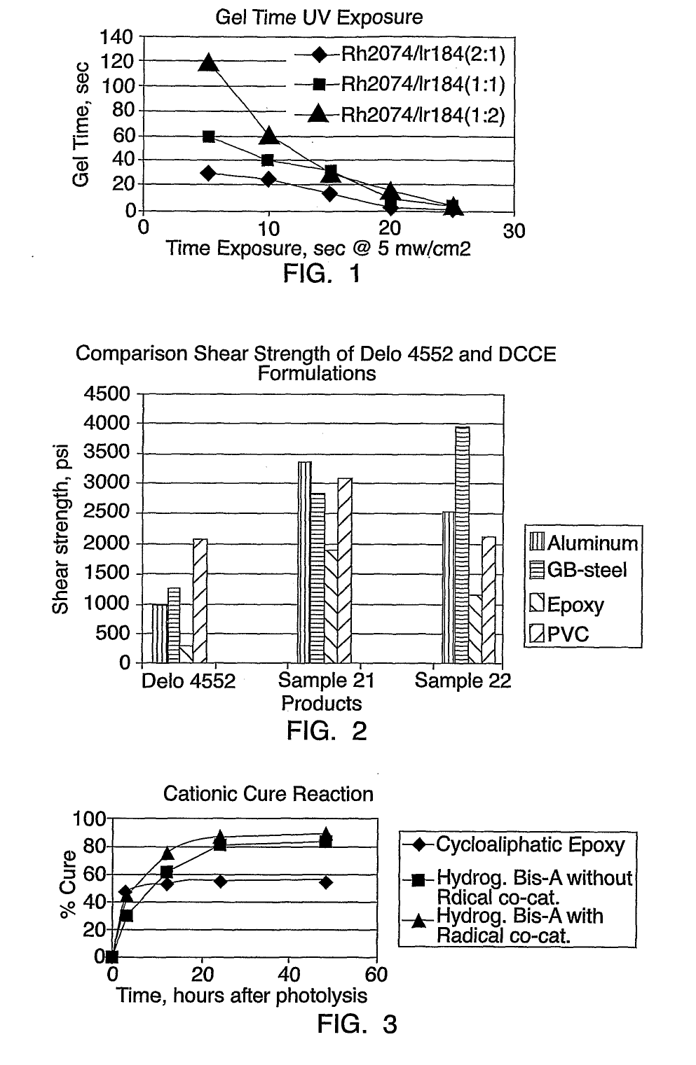

When cured, as described above, for 10 seconds, Sample Nos. 24 and 25 demonstrated improved shear strength over Sample No. 26, DELO 4552, on each the respective substrates. See FIG. 2.

### Example 8

Reference to FIG. 3 shows three samples, as set forth below in terms of constituents and relative weight percent thereof, and their percent cure over time.

Sample No. 27 -- Cycloaliphatic composition:

| | |
|---|---|
| 98% | UVR-6105 (DOW), Cycloaliphatic epoxy resin |
| 2% | RHODOSIL 2074 (Rhodia), cationic photoinitiator |

Sample No. 28 -- Composition without free radical initiator:

| | |
|---|---|
| 98% | EPALLOY 5000 (CVC), hydrogentated bisphenol A epoxy resin |
| 2% | RHODOSIL 2074 (Rhodia), cationic photoinitiator |

Sample No. 29 -- Composition with free radical initiator:

| | |
|---|---|
| 96% | EPALLOY 5000 (CVC), hydrogentated bisphenol A epoxy resin |
| 2% | RHODOSIL 2074 (Rhodia), cationic photoinitiator |
| 2% | IRGACURE 184 (Ciba), free radical phenone initiator |

Compositions within the scope of the invention such as -- Sample Nos. 28 and 29 (represented in the figure as the square and triangle, respectively) --, show a greater percent cure than the comparative composition based on a cycloaliphatic epoxy -- Sample No. 27 (represented in the figure as the diamond).

### Example 9

In this example, visible light (wavelength >400 nm) sensitization of the inventive compositions with camphorquinone (CPQ) is shown below in Tables 16a and 16b:

TABLE 16a

| | | Sample No./ | | |
|---|---|---|---|---|
| Constituents | | Amt. (Wt. %) | | |
| Type | Identity | 30 | 31 | 32 |
| Cationic Photoinitiator | RHODOSIL 2074 | 1 | 1 | 1 |
| Free Radical Initiator | IRGACURE 184 | 1 | 1 | 1 |
| Cyclohexane dimethanol | CHDM | 10 | 10 | 10 |
| Butanediol diglycidyl ether | EPODIL 750 | 10 | 10 | 10 |
| Epoxy | EPONEX 1510 | 78 | 77.5 | 77 |
| Visible Photoinitiator | CPQ | 0 | 0.5 | 1 |

TABLE 16b

| | Sample No. | | | | |
|---|---|---|---|---|---|
| Physical Properties | 30 | 31 | | 32 | |
| Gel time* | No cure | 5-10 | minutes | 2-4 | minutes |
| Shear strength** | No cure | 1110 | psi | 1750 | psi |
| UV shear strength*** | 1860 psi | 1820 | psi | 1790 | psi |

*Time to gel after irradiation for 10 seconds with a 470 nm LED light at 300 mW/cm²
**Grit-blasted steel block shear strength after irradiation with a 470 nm LED followed by 24 hour cure at room temperature
***Grit-blasted steel block shear strength after UV exposure from a medium pressure mercury arc lamp followed by 24 hour cure at room temperature

Without the photoinitiator, CPQ, Sample No. 30 did not cure after visible light exposure, whereas Sample Nos. 31 and 32 did, with the time required for gelation to occur decreasing as the amount of photoinitiator increased as well. Interestingly, shear strength improved dramatically between Sample Nos. 31 and 32.

### Example 10

In this example, a variety of known tougheners and/or flexibilizers were evaluated to determine what if any influence they would show on the inventive compositions. Table 17 shows the identity of certain of these materials and the general influence shown. Not included in the table are the toughening agents, LP-3 (polysulfide toughening agent), HYCAR 1300X31 (carboxy-terminated butadiene nitrile rubber) and EPOSET BPF307 (acrylate rubber dispersed in the diglycidyl ether of bisphenol A and surfactants), which were shown in initial evaluations to be incompatible with the initiator system used in the present invention to establish the delay cure characteristics in the cationic photocurable compositions.

TABLE 17

| Trade Designation | Identity | Comments |
|---|---|---|
| GE 21 | Butanediol diglycidyl ether | Fair adhesion, moderate reactivity |
| KFLEX 128 | Polyether/polyester polyol | Fair adhesion, extreme retardation of cure |
| CHDM | Cyclohexanedimethanol | Fair adhesion, accelerates reaction |
| GE 22 | Cycloheanedimethanol diglycidyl ether | Good adhesion, retards cure |
| CHDM-DVE | Cycloheanedimethanol divinyl ether | No cure |
| GE 5D | Distilled butane glycidyl ether | Fair adhesion, retards cure |
| DER 736 | Polypropylene oxide diglycidyl ether | Fair-good adhesion, retards cure |
| THF-OH | Tetrahydrofurfural alcohol | Fair adhesion, retards cure |
| HELOXY 71 | Epoxidized fatty acid | Poor adhesion, retards cure |
| EPON 1001 | Bis-A diglycidylether, oligomer | Fair adhesion, retards cure |
| VAMAC | Ethylene/methacrylate rubber | Fair adhesion no effect on cure |
| KANEKA RC210C | Acrylate terminated polyacrylate rubber | Good adhesion and toughness but tends to skin over |
| KANEKA OR110S | Siloxane terminated polyacrylate rubber | Good adhesion and toughness |

In Table 18 below, Sample Nos. 33-36 have been prepared to demonstrate some of the different and relative physical properties observed with various tougheners and/or flexibilizers.

TABLE 18

| Constituent | | Sample No./Amt (Wt. %) | | | |
|---|---|---|---|---|---|
| Type | Identity | 33 | 34 | 35 | 36 |
| Rubber | VAMAC | — | 2* | — | — |
| Toughener | KANEKA RC210C | — | — | 7.5 | — |
| | KANEKA OR110S | — | — | — | 7.7 |
| Flexibilizer | GE21 | 15 | 15 | 15 | 15 |
| Epoxy | EPALLOY 5000 | 71.95 | 69.95 | 64.45 | 64.45 |
| Free Radical Initiator | DEAP** | 2 | 2 | 2 | 2 |
| Cationic Photoinitiator | RHODASIL 2074 | 1 | 1 | 1 | 1 |
| Polyether diol | TERETHANE 2000 | 10 | 10 | 10 | 10 |
| Photosensitizer | ITX*** | 0.05 | 0.05 | 0.05 | 0.05 |

*Loading level is limited due to viscosity increase
**Diethylacetophenone
***Isopropyl thioxanthone

In Table 19, physical properties of Sample Nos. 33-35 are illustrated on the various substrates to which they were applied and cured under UV exposure from a medium pressure mercury arc lamp followed by 24 hour cure at room temperature.

TABLE 19

Sample Nos.

| Physical Properties | 33 | 34 | 35 | 36 |
|---|---|---|---|---|
| PVC adhesion (psi) | 1986 | 2212 | 2786 | 2858 |
| PC adhesion (psi) | 1462 | 1870 | 1918 | 2052 |
| Izod impact (Joules) | 0.75 | 1.0 | 1.50 | 1.75 |

Sample No. 33 is used for comparative purposes (without a toughener) and shows the decreased adhesion and toughness (in terms of impact strength) as contrasted with Samples 33-36, each of which having a toughener.

### Example 11

In this example, Tables 20a and 20b shows compositions prepared to illustrate the benefits of using an oxetane in the inventive compositions.

TABLE 20a

| Constituents | | Sample No./Amt. (phr) | | | |
|---|---|---|---|---|---|
| Type | Identity | 37 | 38 | 39 | 40 |
| Epoxy | EPALLOY 5000 | 100 | 100 | 100 | 100 |
| Oxetane | A | 20 | — | — | — |
| | B | — | 20 | — | — |
| | C | — | — | 20 | — |
| Cationic Photoinitiator | RHODASIL 2074 | 2 | 2 | 2 | 2 |
| Free Radical Initiator | IRGACURE 184 | — | — | — | — |

TABLE 20b

| Constituents | | Sample No./Amt. (phr) | | | |
|---|---|---|---|---|---|
| Type | Identity | 41 | 42 | 43 | 44 |
| Epoxy | EPALLOY 5000 | 100 | 100 | 100 | 100 |
| Oxetane | A | 20 | — | — | — |
| | B | — | 20 | — | — |
| | C | — | — | 20 | — |
| Cationic Photoinitiator | RHODASIL 2074 | 2 | 2 | 2 | 2 |
| Free Radical Initiator | IRGACURE 184 | 1 | 1 | 1 | 1 |

The samples were each applied to a grit blasted steel lap shear, and exposed to radiation in the ultraviolet range of the electromagnetic spectrum at an intensity of 140 mW/cm² for either 5 seconds for the comparative ones (Sample Nos. 40 and 44), Sample Nos. 37 and 41, and Sample Nos. 39 and 43, or 20 seconds for Sample Nos. 38 and 42.

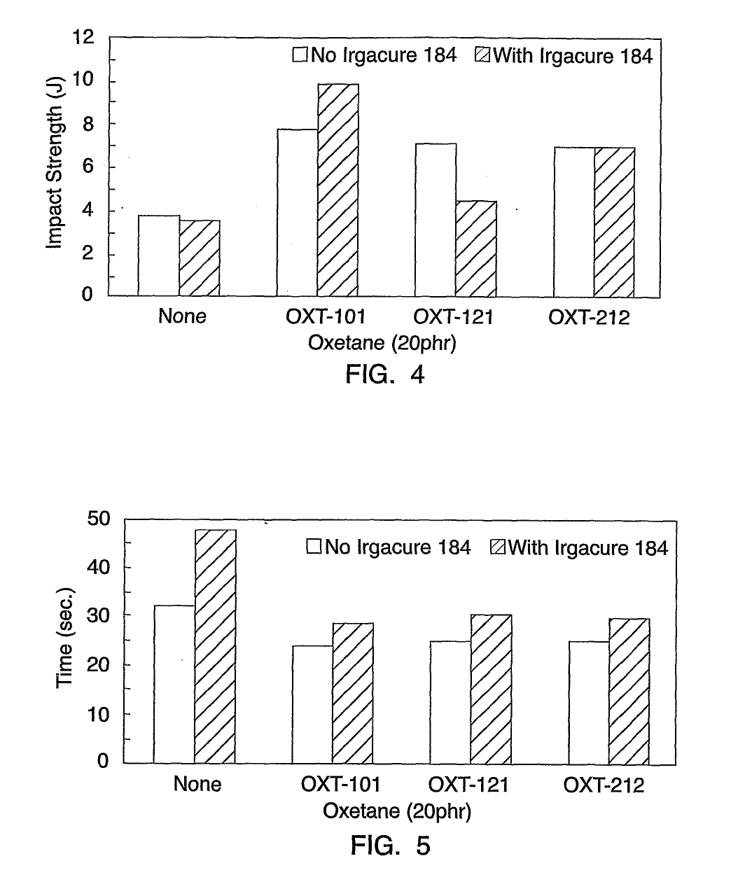

Thereafter, a second lap shear was applied thereover such that a one inch overlap existed between the lap shears with the sample therebetween. In order to ensure complete cure, the assembled lap shear specimens were further exposed to a temperature of 150° C. for one hour, after which they were tested for impact strength. Reference to FIGS. 4-5 show some observations from these samples.

For instance, FIG. 4 shows an improvement in the observed impact strength of the inventive compositions when an oxetane is added to the composition. In addition, in connection with Sample No. 41 a further improvement in impact strength is seen when the free radical initiator is included, as contrasted to Sample No. 37, where one was not included.

In addition, FIG. 5 shows that while the addition of an oxetane to a composition increases the rate at which a peak maximum is reached (and thus its cure), the inclusion of the free radical initiator retards that rate yet again (though not to the levels observed when no oxetane has been included).

1. A photoinitiated cationically curable composition, comprising:
(a) an aliphatic epoxy resin, at least a portion of which includes an aliphatic glycidyl ether epoxy resin;
(b) a cationic photoinitiator; and
(c) a free radical initiator,
wherein when used to bond two substrates, at least one of which has less than 50% optical transmission, the composition is capable of curing through a volume between the two substrates of at least about 1 mm when exposed to appropriate radiation in the electromagnetic spectrum.

2. The composition according to claim 1, wherein the aliphatic glycidyl ether has a hydrogenated aromatic backbone.

3. The composition according to claim 1, wherein the aliphatic glycidyl ether is a diglycidyl ether aliphatic epoxy resin having a backbone selected from the group consisting of hydrogenated bisphenol A, hydrogenated bisphenol F, hydrogenated bisphenol S and hydrogenated biphenyl.

4. A photoinitiated cationically curable composition, comprising:
(a) an aliphatic epoxy resin, at least a portion of which includes an aliphatic glycidyl ether epoxy resin selected from the group consisting of hydrogenated bisphenol A, hydrogenated bisphenol F, hydrogenated bisphenol S and hydrogenated biphenyl; and
(b) a cationic photoinitiator,
wherein when used to bond two substrates, at least one of which has less than 50% optical transmission, the composition is capable of curing through a volume between the two substrates of at least about mm when exposed to appropriate radiation In the electromagnetic spectrum.

5. A catonic photoinitiator photoinitiated cationically curable epoxy composition, comprising:
(a) a non-aromatic glycidyl ether epoxy component; and
(b) an initiator component comprising the combination of a cationic photoinitiator and a free radical initiator, wherein, when exposed to appropriate radiation in the electromagnetic spectrum, the composition achieves an open time of from 1 second to about five minutes, and develops greater than about 85% of its ultimate strength after a period of time of 24 hours at room temperature.

6. The composition of claim 1, wherein the free radical initiator comprises a phenone initiator.

7. The composition of claim 1, wherein the free radical initiator is selected from the group consisting of 1-hydroxy cyclohexyl phenyl ketone 2,2-di-methoxy-2-phenyl acetophenone, 1-hydroxy cyclohexyl phenyl ketone, benzophenone, 2-benzyl-2-N,N-dimethylamino-1-(4-morpholino phenyl)-1-butane 2-methyl-1-[-4(methylthio)phenyl]-2-morpholino propane-1-one, 2-hydroxyl-2-methyl-1-phenyl-propane-1-one, 1-hydroxycyclohexyl phenyl ketone, 2,2-dimethoxy-2-phenyl acetophenone, 4-(2-hydroxyethyoxy)phenyl-(2-hydroxy-2-methylpropyl)ketone, 2,4,6-trimethylbenzoyl-diphenylphosphine oxide, and combinations thereof.

8. The composition of claim 1, wherein the cationic photoinitiator is selected from the group consisting of triarylsulfonium, diaryliodonium and aryl diazonium salts containing non-nucleophilic counterions, 4-methoxybenzenediazonium hexafluorophosphate, benzenediazonium tetrafluoroborate, diphenyl iodonium chloride, diphenyl iodonium hexafluorophosphate, 4,4-dioctyloxydiphenyl iodonium hexafluorophosphate, triphenylsulfonium tetrafluoroborate, diphenlytolylsulfonium hexafluorophosphate, phenylditolylsulfonium hexafluoroarsenate, diphenyl-thiophenoxyphenylsulfonium hexafluoroantimonate, triaryl sulfonium hexafluoroantimonate, triaryl sulfonium hexafluorophosphate and diaryl iodonium hexafluoroantimonate.

9. The composition of claim 1, wherein the cationic photoinitiator is selected from the group consisting of triarylsulfonium, diaryliodonium and aryl diazonium salts containing non-nucleophilic counterions.

10. The composition of claim 1, wherein the aliphatic glycidyl ether is embraced by the following structure: 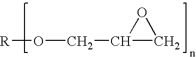
wherein n is 1-7 and R is any non-aromatic hydrocarbon, optionally containing ether or ester linkages.

11. The composition of claim 1, wherein the composition achieves greater than about 85% of its ultimate strength without exposure to elevated temperature conditions.

12. The composition of claim 1, wherein the cationic photoinitiator and the free radical phenone co-initiator are used in a ratio of 4:1 to 1:2.5.

13. A method of bonding substrates, at least one of which having greater than 50% optical transmission, steps of which comprise:
providing a first substrate,
providing a second substrate, wherein at least one of the first and second substrates which has less than 50% optical transmission,
providing a composition according to claim 1 on at least one of the first or second substrates,
exposing the composition to conditions sufficient to initiate cure thereof, and
mating the first and second substrates, and allowing the composition to achieve greater than 85% of its ultimate strength.

14-15. (canceled)

16. The composition according to claim 1, wherein the epoxy resin component is a member selected from the group consisting of C₄ -C₇₀ alkyl glycidyl ethers; C₂ -C₇₀ alkyl- and alkenyl-glycidyl esters; C₁-C₇₀ alkyl-, mono- and poly-hydrogenated phenolic glycidyl ethers; polyglycidyl ethers of hydrogenated pyrocatechol, hydrogenated resorcinol, hydrogenated hydroquinone, 4,4′-dihydroxydicyclohexyl methane, 4,4′-dihydroxy-3,3′-dihydroxydicyclohexyl methane, 4,4′-dihydroxydicyclohexyl dimethyl methane, 4,4′-dihydroxydicyclohexyl methyl methane, 4,4′-dihydroxydicyclohexyl cyclohexane, 4,4′-dihydroxy-3,3′-dimethyldicyclohexyl propane, 4,4′-dihydroxydicyclohexyl sulfone, and tris(4-hydroxycyclohexyl)methane, and combinations thereof.

17. (canceled)

18. The composition according to claim 1, wherein the cationic photoinitiator includes a cationic counter ion within the following structure: 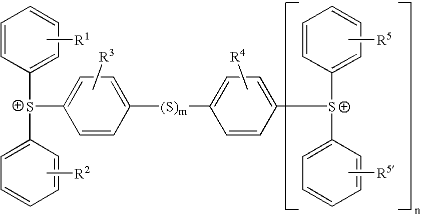
wherein R¹, R², R³, R⁴, R⁵ and R⁵′ may or may not be present, but when not present are hydrogen and when any are present may individually be selected from C₁₋₆ alkyl, C₂₋₆ alkenyl, halogen, hydroxyl and carboxyl, with R¹, R², R⁵ and R⁵′ being present individually up to 5 times on each aromatic ring to which it(they) is(are) attached, and R³ and R⁴ being present individually up to 4 times on each aromatic ring to which it(they) is(are) attached, n is 0-3 and m is 0-1.

19. The composition according to claim 1, wherein the cationic photoinitiator includes a counter ion selected from the group consisting of

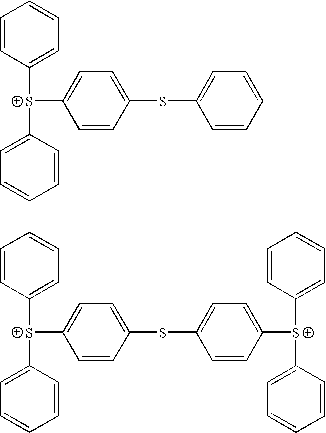

20. The composition according to claim 1, wherein the cationic photoinitiator includes a counter ion selected from the group consisting of 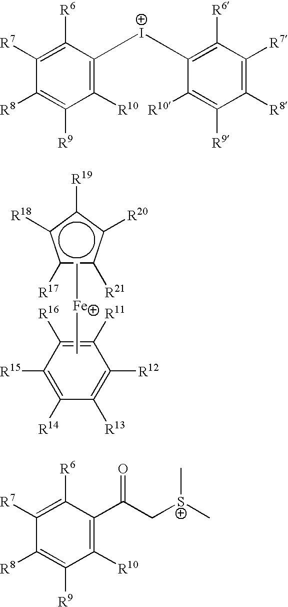
wherein for structure IV R⁶, R⁷, R⁸, R⁹ and R¹⁰ may or may not be present, but when not present are hydrogen and when any are present may individually be selected from the group consisting of alkyl of from 1 to 5 carbon atoms, halogen, hydroxyl, and carboxyl, for of structure V R⁶, R⁷, R⁸, R⁹, R¹⁰, R⁶′, R⁷′, R⁸′, R⁹′, and R¹⁰′ may or may not be present, but when not present are hydrogen and when any are present may individually be selected from the group consisting of alkyl of from 1 to 5 carbon atoms, halogen, hydroxyl, and carboxyl, and for structure VI R¹¹, R¹², R¹³, R¹⁴, R¹⁵, R¹⁶, R¹⁷, R¹⁸, R¹⁹, R²⁰, and R²¹ may or may not be present, but when not present are hydrogen and when any are present may individually be selected from the group consisting of alkyl of from 1 to 5 carbon atoms, halogen, hydroxyl, and carboxyl.

21. The composition according to claim 1, wherein the cationic photoinitiator includes a counter ion selected from the group consisting of

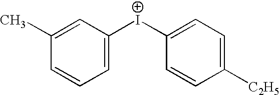

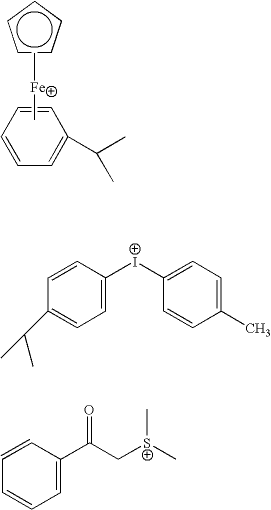

22-24. (canceled)

25. The composition according to claim 1, further comprising an oxetane-containing compound.

26. (canceled)

27. The composition according to claim 25, wherein the oxetane-containing compound is a member selected from the gropu consisting of

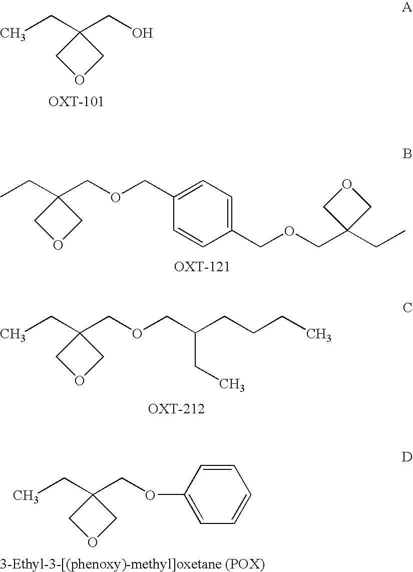

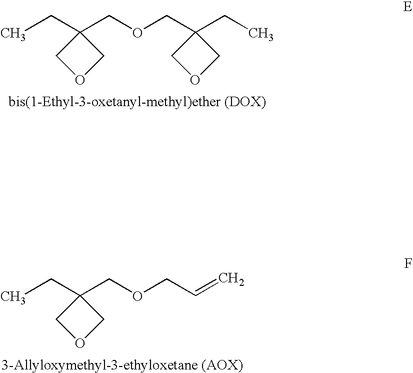

28. The composition according to claim 25, wherein the oxetane-containing compound improves at least one of the following physical properties: photocure, tougheness, and adhesion.

29. The composition according to claim 1, further comprising a photoinitiator triggered by exposure to radiation in the visible range of the electromagnetic spectrum.

30. The composition according to claim 1, further comprising a (meth)acrylate-terminated polyacrylate.

31. The composition according to claim 30, wherein the (meth)acrylate-terminated polyacrylate is an alkoxy silyl-terminated polyacrylate.
